(19) United States
(12) Patent Application Publication
(10) Pub. No.: US 2026/0142459 A1
(43) Pub. Date: May 21, 2026

(54) METHOD AND SYSTEM FOR POST-DISASTER POWER RESTORATION IN POWER GRID, AND STORAGE MEDIUM

(71) Applicant: NANJING UNIVERSITY OF SCIENCE AND TECHNOLOGY, Nanjing (CN)

(72) Inventors: Yunyun XIE, Nanjing (CN); Sheng Cai, Nanjing (CN); Jiawei Han, Nanjing (CN); Yuping Zhang, Nanjing (CN); Lei Yu, Nanjing (CN)

(21) Appl. No.: 19/442,945

(22) Filed: Jan. 7, 2026

(30) Foreign Application Priority Data
Jan. 10, 2025 (CN) 202510043000.8

(51) Int. Cl. H02J 3/001; H02J 3/466; H02J 103/35

(52) U.S. Cl. CPC H02J 3/001; H02J 3/466; H02J 2103/35

(57) ABSTRACT

A method and system for post-disaster power restoration in a power grid, and a storage medium are disclosed. The method includes acquiring the target data of the disaster-affected area; constructing overall constraints; determining the travel trajectory of refueling vehicles and their fuel delivery amount at each gas turbine node, the output power of each gas turbine, and the load restoration amount of each load node; and controlling the operating status of load nodes and the output power of gas turbines, and the fuel delivery by refueling vehicles to each gas turbine node based on the travel trajectory of refueling vehicles, the fuel delivery amount of refueling vehicles at each gas turbine node, the output power of each gas turbine and the load restoration amount of each load node.

### TECHNICAL FIELD

The present disclosure belongs to the technical field of power grids, and particularly relates to a method and system for post-disaster power restoration in a power grid, and a storage medium.

### BACKGROUND

In recent years, the frequent occurrence of natural disasters has posed unprecedented challenges to safe and reliable operation of power systems. Natural disasters often exceed normal design standards of power systems, making power infrastructure susceptible to widespread and massive physical failures, which in turn leads to power outages for users.

With the large-scale integration of distributed energy resources into power distribution systems, a foundation has been laid for achieving resilient post-disaster operation of power grids. In outage areas, utilizing distributed energy resources to form microgrids, thereby restoring power to critical loads, can effectively reduce both the scale and duration of power outages. For example, a city can build several microgrids based on important loads, with gas turbines pre-installed in the microgrid to supply emergency power to the important loads. When the upstream power grid is disturbed due to a natural disaster, causing a city-wide power outage, the gas turbines can be immediately activated and provide emergency power to the important loads in an island mode by relying on microgrids.

However, the reliable operation of the gas turbines depends on a guaranteed and sufficient fuel supply. Should this supply become inadequate, the turbines will fail, potentially causing renewed power outages for the critical loads already restored within the microgrids. This, in turn, can severely disrupt essential urban infrastructure and services.

### SUMMARY

In view of the above problems, it is necessary to provide a method and system for post-disaster power restoration in a power grid, and a storage medium, to improve the reliability of the post-disaster restoration process of the power grid.

According to a first aspect, the present disclosure provides a method for post-disaster power restoration in a power grid, including the following steps:

acquiring the target data of the disaster-affected area. In this area, there exist gas turbine nodes and load nodes. The gas turbine nodes are designed to supply power via gas turbines under disaster conditions. The target data comprises topological data of the power grid in the disaster-affected area, gas turbine data, load data, road data, the state of refueling vehicles in the disaster-affected area, and the location of grid faults;

constructing overall constraints based on the relationship between the output power of gas turbine and its fuel consumption, as well as the correlation between the fuel delivery amount and the travel status of the refueling vehicle;

determining the following variables based on the target data and subject to the overall constraint, with an objective of maximizing the weighted load restoration during the fault duration: the travel trajectory of refueling vehicles and their fuel delivery amount at each gas turbine node, the output power of each gas turbine, and the load restoration amount of each load node. Herein, the weighted load restoration is calculated as the weighted sum power supplied to all load nodoes throughout the fault, where each load node has a corresponding load weight; and

Controlling the operating status of load nodes and the output power of gas turbines, and the fuel delivery by refueling vehicles to each gas turbine node based on the travel trajectory of refueling vehicles, the fuel delivery amount of the refueling vehicle at each gas turbine node, the output power of each gas turbine and the load restoration amount of each load node.

Further, constructing the overall constraints based on the relationship between the output power of gas turbine and its fuel consumption, as well as the correlation between the fuel delivery amount and the travel status of the refueling vehicle includes:

constructing the travel constraints of refueling vehicles, wherein the travel constraints of refueling vehicles are used for indicating a unique position of the refueling vehicle in the disaster-affected area at any time;

constructing the fuel delivery constraints of refueling vehicles, wherein the fuel delivery constraints of refueling vehicles are used for presenting the variation in the fuel quantity of a refueling vehicle between any two consecutive time steps. This variation comprises the replenishment amount received by the vehicle and the fuel supply amount delivered when it passes through a gas turbine node;

constructing the fuel consumption constraints of gas turbines, wherein the fuel consumption constraints of gas turbines are used for indicating the fuel consumption amount of gas turbines between any two adjacent times;

constructing the power output constraints of gas turbines, wherein the power output constraints are used for indicating the relationship between the power output of gas turbine and its fuel consumption amount;

constructing the power flow constraints of the power grid, wherein the power flow constraints of the power grid are used for indicating the energy flow state between any two adjacent nodes, and the nodes comprise the gas turbine nodes and the load nodes; and

combining, according to the relationship between the output power of gas turbine and its fuel consumption, as well as the correlation between the fuel delivery amount and the travel status of the refueling vehicle, the travel constraints of refueling vehicles, the fuel delivery constraints of refueling vehicles, the fuel consumption constraints of gas turbines, the power output constraints of gas turbines and the power flow constraints of the power grid to generate the overall constraints.

Further, the travel constraints of refueling vehicles comprises: the travel status of the refueling vehicle satisfies the following first constraint:

$$\{ \begin{matrix}{α}_{f . t} \geq {\sum }_{n ∈ {N}_{M}} {v}_{f . n . t - 1} + {\sum }_{n ∈ {N}_{M}} {v}_{f . n . t} - 2 + ε \\ - ( 1 - {α}_{f . t} ) \leq {v}_{f . n . t} - {v}_{f . n . t - 1} \leq ( 1 - {α}_{f . t} )\end{matrix} , f ∈ F , n ∈ {N}_{M} , t ∈ T$$

where N_{M} is the set of nodes in a traffic network; F is the set of the refueling vehicles; T is the set of scheduling time scales; ν_{f.n.t} and ν_{f.n.t-1} are binary variables indicating whether refueling vehicle f is located at node n at time step t and time step t−1; ε is a small positive constant; a_{f.t} is a binary variable that indicate whether the refueling vehicle f is in the travle status between time step t−1 and time step t;

wherein the refueling vehicle satisfies the following second constraint between the stationary status and the travel status:

$${\sum }_{n ∈ {N}_{M}} {x}_{f . n . t} + {\sum }_{n ∈ {N}_{M}} {v}_{f . n . t} = 1 , f ∈ F , t ∈ T$$

where x_{f.n.t} is a binary variable indicating whether the refueling vehicle f stops at node n at time step t;

the transition between the stationary status and the travel status of refueling vehicles satisfies the following third constraint:

$$\{ \begin{matrix}{x}_{f . n . t + 1} \geq {x}_{f . n . t} + 1.2 ( {v}_{f . n . t} - {v}_{f . n . t + 1} ) + 0.4 ( {\sum }_{n ∈ {N}_{M}} {v}_{f . n . t} - {\sum }_{n ∈ {N}_{M}} {v}_{f . n . t + 1} ) - 0.8 \\ {x}_{f . n . t + 1} \leq {x}_{f . n . t} + ( {v}_{f . n . t} - {v}_{f . n . t + 1} ) - 0.5 ( {\sum }_{n ∈ {N}_{M}} {v}_{f . n . t} - {\sum }_{n ∈ {N}_{M}} {v}_{f . n . t + 1} ) + 0.7\end{matrix} , f ∈ F , n ∈ {N}_{M} , t ∈ T ∖ \{ D \}$$

the travel status of the refueling vehicle is subject to the following fourth constraint:

$${R}_{f . t} / ϕ \leq {\sum }_{n ∈ {N}_{M}} {v}_{f . n . t} \leq {R}_{f . t} , f ∈ F , t ∈ T$$

where R_{f.t} indicates the residual travel time of the refueling vehicle f at time step t, and φ is a large constant;

the residual travel time of refueling vehicles satisfies the following fifth constraint:

$$\{ \begin{matrix}{R}_{f \text{.1}} = {C}_{f \text{.1}} , f ∈ F \\ {R}_{f . t} = {R}_{f . t - 1} + {C}_{f . t} - {\sum }_{n ∈ {N}_{M}} {v}_{f . n . t - 1} , f ∈ F , t ∈ T ∖ \{ 1 \}\end{matrix}$$

where R_{f.t-1} indicates the residual travel time of refueling vehicle f at time step t−1, and R_{f.1} represents the residual travel time of refueling vehicle f at the first time step;

calculating the travel time required for the refueling vehicle at each time satisfies the following sixth constraint:

$$\{ \begin{matrix}{C}_{f \text{.1}} \geq {\sum }_{{n}^{′} ∈ {N}_{M}} {v}_{f . {n}^{′} \text{.1}} {T}_{f . {nn}^{′}} , f ∈ F , n ∈ {N}_{M} \\ {C}_{f . t} \geq {x}_{f . n . t - 1} {\sum }_{{n}^{′} ∈ {N}_{M}} {T}_{f . {nn}^{′}} + {\sum }_{{n}^{′} ∈ {N}_{M}} {v}_{f . {n}^{′} . t} {T}_{f , {nn}^{′}} - {\sum }_{{n}^{′} ∈ {N}_{M}} {T}_{f . {nn}^{′}} , f ∈ F , n ∈ {N}_{M} , t ∈ T ∖ \{ 1 \} \\ {C}_{f . t} \geq 0 , f ∈ F , t ∈ T\end{matrix}$$

where V_{f.n′.1} indicates whether refueling vehicle f is located at node n′ at the first time step, ν_{f.n′.t} indicates whether refueling vehicle f is located at node n′ at time step t, C_{f.t} indicates the travel time to be consumed by refueling vehicle f at time step t, and C_{f.1} indicates the travel time to be consumed by refueling vehicle f at the first time step; T_{f.nn′} indicates the number of time steps required for refueling vehicle f to move from node n to node n′.

Further, the fuel delivery constraints of refueling vehicles comprise:

$${S}_{f . t}^{F} = {S}_{f . t - 1}^{F} + {V}_{f . t} - {\sum }_{n ∈ {N}_{M}} {U}_{f . n . t} , f ∈ F , t ∈ T$$

$$0 \leq {U}_{f . n . t} \leq {x}_{f . n . t} {W}_{f}^{F} , f ∈ F , n ∈ {N}_{M} , t ∈ T$$

$$0 \leq {V}_{f . t} \leq {x}_{f . n = k . t} {W}_{f}^{F} , f ∈ F , t ∈ T$$

where

$${S}_{f . t}^{F} and {S}_{f . t - 1}^{F}$$

indicate the remaining fuel amount of refueling vehicle f at time step t and at time step t−1, respectively; N_{M} is the set of nodes in a traffic network; V_{f.t} indicates a fuel replenishment amount of refueling vehicle f at time step t; U_{f.n.t} indicates a fuel delivery amount of refueling vehicle f at node n at time step t;

$${W}_{f}^{F}$$

indicates the fuel loading capacity of refueling vehicle f; x_{f.n=k.t} is a binary variable that indicates whether refueling vehicle f stops at the node where a refueling station is located at time step t, i.e., n=k; and

the remaining fuel amount of refueling vehicles satisfies the following seventh constraint:

$$0 \leq {S}_{f . t}^{F} \leq {W}_{f}^{F} , f ∈ F , t ∈ T$$

Further, the fuel consumption constraints of gas turbines comprise:

the remaining fuel amount of the gas turbine satisfies the following eighth constraint:

$${S}_{g . t}^{G} = {S}_{g . t - 1}^{G} + {\sum }_{f ∈ F} {U}_{f . n = g . t} - {B}_{g . t} , g ∈ G , t ∈ T$$

where G is the set of gas turbines;

$${S}_{g . t}^{G} and {S}_{g . t - 1}^{G}$$

indicate the remaining fuel amount of gas turbine g at time step t and time step t−1, respectively, U_{f.n=g.f} indicates the fuel delivery amount of refueling vehicle f at node n connected with gas turbine g at time step t, and B_{g.t} indicates the fuel consumption amount of gas turbine g at time step t; and

the fuel consumption mount of the gas turbine satisfies the following ninth constraint:

$${B}_{g . t} = {a}_{g . r} {P}_{g . t} + {b}_{g . r} , if {P}_{g . t} ∈ [ {p}_{g . r - 1} , {p}_{g . r} ]$$

where B_{g.t} indicates the fuel consumption amount of gas turbine g at time step t; P_{g.t} indicates the active power output of gas turbine g at time step t; a_{g.r} is a coefficient of an r-th piecewise linear term of the fuel consumption function of gas turbine g; b_{g.r} is a coefficient of the r-th constant term of the fuel consumption function of gas turbine g; p_{g.r} is an r-th breakpoint of the fuel consumption function of gas turbine g, and p_{g.r-1} is an (r−1)-th breakpoint of the fuel consumption function of gas turbine g.

Further, the power output constraints of gas turbines comprise:

$${P}_{g}^{G . min} \leq {P}_{g . t}^{G} \leq {P}_{g}^{G . max} , g ∈ G , t ∈ T$$

$${Q}_{g}^{G . min} \leq {Q}_{g . t}^{G} \leq {Q}_{g}^{G . max} , g ∈ G , t ∈ T$$

where G is the set of the gas turbines, and

$${P}_{g . t}^{G}$$

indicates the active power output of gas turbine g at time step t;

$${Q}_{g . t}^{G}$$

indicates the reactive power output of gas turbine g at time step t;

$${P}_{g}^{G . min} and {P}_{g}^{G . max}$$

indicate the lower limit and the upper limit of the active power output of gas turbine g, respectively;

$${Q}_{g}^{G . min} and {Q}_{g}^{G . max}$$

indicate the lower limit and the upper limit of the reactive power output of gas turbine g, respectively.

Further, the power flow constraints of the power grid comprise:

$${\sum }_{h : ( h , i ) ∈ B} {p}_{hi . t}^{BR} = {\sum }_{j : ( i , j ) ∈ B} {p}_{ij . t}^{BR} + {P}_{i . t} - {P}_{i . t}^{G} , ∀ i ∈ N , ∀ t$$

$${\sum }_{h : ( h , i ) ∈ B} {q}_{hi . t}^{BR} = {\sum }_{j : ( i , j ) ∈ B} {q}_{ij . t}^{BR} + {Q}_{i . t} - {Q}_{i . t}^{G} , ∀ i ∈ N , ∀ t$$

$${Y}_{hi}^{P . min} \cdot {u}_{hi}^{B} \leq {p}_{hi . t}^{BR} \leq {Y}_{hi}^{P . max} \cdot {u}_{hi}^{B} , ∀ ( h , i ) ∈ B , ∀ t$$

$${Y}_{hi}^{Q . min} \cdot {u}_{ij}^{B} \leq {q}_{hi . t}^{BR} \leq {Y}_{hi}^{Q . max} \cdot {u}_{ij}^{B} , ∀ ( h , i ) ∈ B , ∀ t$$

where N is the set of nodes; B is the set of lines;

$${p}_{hi . t}^{B R} and {p}_{ij . t}^{B R}$$

respectively indicate active powers flowing through the line (h,i) and the line (i,j) at time step t;

$${q}_{hi . t}^{B R} and {q}_{ij . t}^{B R}$$

respectively indicate reactive power flowing through the line (h,i) and the line (i,j) at time step t;

$${P}_{i . t}^{G}$$

indicates the active power output of the gas turbine connected at node i at time step t;

$${Q}_{i . t}^{G}$$

indicates a reactive power output of the gas turbine connected at node i at time step t; P_{i.t} indicates the active power restoration amount of the load at node i at time step t; Q_{i.t}, indicates the reactive power restoration amount of the load at node i at time step t;

$${u}_{h i}^{B}$$

is used to characterize whether the line (h,i) its in the fault state,

$${u}_{h i}^{B} = 0$$

indicates the line is in the fault state, otherwise

$${u}_{h i}^{B} = 1 ; {u}_{i j}^{B}$$

is used to characterize whether the line (i,j) is in the fault state; if the line (i,j) is in the fault state,

$${u}_{i j}^{B} = 0$$

indicates the line is in the fault state, otherwise

$${u}_{i j}^{B} = 1 ; {Y}_{h i}^{P . m i n}$$

indicates the minimum active power allowable through line (h,i);

$${Y}_{h i}^{P . m ax}$$

indicates the maximum active power allowable through line (h,i);

$${Y}_{h i}^{Q . m i n}$$

indicates the minimum reactive power allowable through line (h,i);

$${Y}_{h i}^{Q . m ax}$$

indicates the maximum reactive power allowable through line (h,i).

Further, determining the following variables based on the target data and subject to the overall constraint, with an objective of maximizing the weighted load restoration during the fault duration: the travel trajectory of refueling vehicles and their fuel delivery amount at each gas turbine node, the output power of each gas turbine, and the load restoration amount of each load node, comprises:

obtaining, subject to the overall constraints and with the power restoration objective of maximizing the weighted load restoration amount during the fault duration, the travel trajectory of the refueling vehicle on the roads in the disaster-affected area, the fuel delivery amount of the refueling vehicle at each gas turbine node, the output power of each gas turbine and the load restoration amount of each load node through mathematical planning by a mathematical planner.

Further, the mathematical planner is one of an integer planner, a liner planner or a mixed integer linear planner.

Further, controlling the operating status of load nodes and the output power of gas turbines, and the fuel delivery by refueling vehicles to each gas turbine node based on the travel trajectory of refueling vehicles, the fuel delivery amount of the refueling vehicle at each gas turbine node, the output power of each gas turbine and the load restoration amount of each load node comprises:
generating the refueling vehicle scheduling control instruction, the gas turbine scheduling instruction, and the load node scheduling instruction according to the travel trajectory of the refueling vehicle on the roads in the disaster-affected area, the fuel delivery of the refueling vehicle at each gas turbine node, the output power of each gas turbine and the load restoration amount of each load node, wherein the refueling vehicle scheduling control instruction comprises the driving route, the departure time, the fuel delivery amount, and the stop node of the refueling vehicle;
controlling the output power of gas turbines according to the gas turbine scheduling instruction;
controlling the operating status and load restoration amount of the load node according to the load node scheduling instruction; and
controlling the refueling vehicle to deliver fuel to each gas turbine node according to the refueling vehicle scheduling control instruction.

Further, the refueling vehicle scheduling control instruction comprises time series data of each refueling vehicle, and the time series data comprises an expected travel path, an expected position and expected remaining fuel amount of the refueling vehicle at each time node.

According to a second aspect, the present disclosure provides a system for post-disaster power restoration system in a power grid, comprising a microgrid controller, a refueling vehicle and gas turbines, wherein the microgrid controller, the refueling vehicle and the gas turbines are all equipped with communication modules;

the microgrid controller is configured to generate a control instruction for the refueling vehicle by means of the method according to the first aspect above after acquiring target data of a disaster-affected area;

the microgrid controller is configured to send the control instruction to the refueling vehicle;

the refueling vehicle, after receiving the control instruction, is configured to select the gas turbine according to the control instruction and drives to the gas turbine to deliver fuel to the gas turbine.

Further, one or more refueling vehicles are prepared in the disaster-affected area, the microgrid controller acquires states of the refueling vehicles in the disaster-affected area in real time by means of the communication modules, and the state of the refueling vehicle comprises the travel path, the position and the remaining fuel amount of the refueling vehicles.

Further, the system further comprising load node devices, wherein the microgrid controller is also configured to generate load node scheduling instructions and gas turbine scheduling instructions by means of the method according to the first aspect above after acquiring the target data of the disaster-affected area, send the load node scheduling instructions to the load node devices and the gas turbine scheduling instructions to the gas turbines; and

the load node scheduling instruction is used for controlling the operating status of load nodes, and the gas turbine dispatching instruction is used for controlling an output power of the gas turbine.

According to a third aspect, the present disclosure provides a computer-readable storage medium, storing a computer program, wherein the computer program, when executed by a processor, implements the method according to the first aspect above.

Compared with the prior art, the present disclosure has the following significant advantages.

In the present disclosure, the travel status, path and fuel delivery action of refueling vehicles are taken as core decision variables, the traffic network and the power grid are coupled through an overall constraints, and with an objective of maximizing a weighted load restoration amount, an optimal solution considering the traffic network and the power grid simultaneously is obtained to control output powers of gas turbines and operating status of load nodes; then, energy is actively supplied to the gas turbines according to the accurately calculated travel status, path and fuel delivery action of the refueling vehicles to ensure that key power generation resources can continuously receive fuel throughout the entire duration of a fault. This greatly improves the reliability and sustainability of the power restoration plan.

### BRIEF DESCRIPTION OF THE DRAWINGS

FIG. 1 is a flowchart of a method for post-disaster power restoration in a power grid according to the present disclosure.

FIG. 2 is a schematic diagram of an IEEE14 node test system according to an embodiment of the present disclosure.

FIG. 3 is a schematic diagram of a load restoration amount under different restoration strategies according to an embodiment of the present disclosure.

### DETAILED DESCRIPTION OF THE EMBODIMENTS

To better clarify the purposes, technical solutions and advantages of the present disclosure, the present disclosure is further described in detail below in conjunction with accompanying drawings and embodiments. It should be understood that the specific embodiments described here are merely used for explaining the present disclosure rather than limiting the present disclosure.

In addition, if the embodiments of the present disclosure involve descriptions of terms such as “first” and “second”, these descriptions are merely used for the descriptive purposes and should not be interpreted as indicating or implying relative importance or as specifying the number of technical features indicated. Therefore, features defined by “first” or “second” may explicitly or implicitly indicate at least one of such features. In addition, the technical solutions in different embodiments may be combined with each other, but must be based on the ability of those ordinarily skilled in the art to implement them. If the combination of the technical solutions leads to contradictions or impossibilities, such a combination should be considered non-existent and should not fall within the protection scope of the present disclosure.

In recent years, the frequency of natural disasters has been increasing, and extreme weather events are showing a trend towards normalization. Under the impact of such natural disasters, a power system often suffers from external shocks that exceed its conventional design standards, making power infrastructure highly susceptible to widespread and mass physical damage, which in turn leads to large-scale power outages in a power distribution network. The large-scale power outages not only affect the lives of residents, but also may leave important loads such as hospitals, communication hubs and emergency command centers without power, bringing significant social and economic losses.

With the increasing penetration of distributed energy resources in a power distribution network, microgrids constructed based on distributed energy resources are gradually becoming an important means to enhance the post-disaster elasticity of power systems. In areas not directly affected by disasters, the user of independent or quasi-independent microgrids formed by distributed energy resources may achieve rapid power restoration to critical users, effectively reducing the scope of power outages and shortening the duration of the power outages. For example, microgrids centered around distributed energy resources such as gas turbines are typically constructed in critical areas of certain cities to supply emergency power to important loads when a main power grid fails.

However, the gas turbines have a strong dependence on fuel supply during operation. When disasters disrupt the gas supply chain or result in insufficient fuel supply, the gas turbines may not be able to maintain stable operation, causing the important loads that have had power restored to lose power again. This problem directly affects the reliable operation of critical city functions and undermines the role of microgrids in post-disaster restoration. Therefore, how to ensure continuous operation of the gas turbines under limited post-disaster energy supply conditions is an important technical challenge to the improvement of the power supply elasticity of the microgrid.

The present disclosure addresses the coupling between power generation by the gas turbines and fuel delivery by refueling vehicles in post-disaster restoration of a microgrid. The present disclosure improves the actual power restoration capability of the microgrid under a fault condition by jointly scheduling multiple engineering subsystems such as travel states of the vehicles, a physical power flow constraint of the power grid and a fuel consumption model, thereby achieving a technical improvement on the operating performance of a power system.

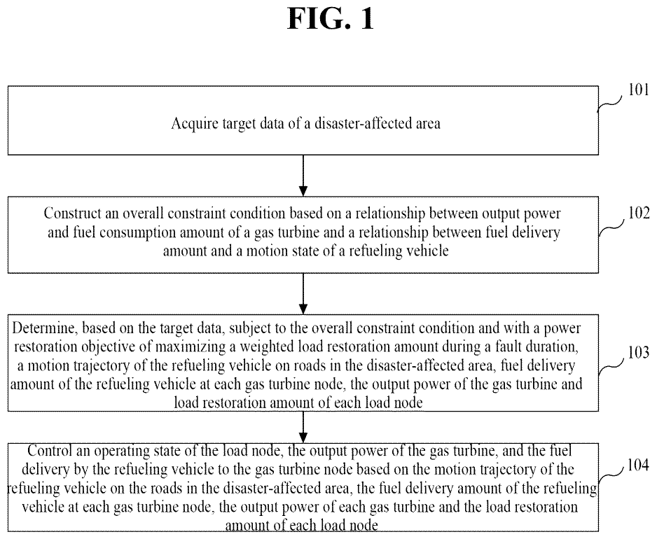

In conjunction with FIG. 1, the present disclosure provides a method for post-disaster power restoration in a power grid. The method for post-disaster power restoration in the power grid may be applied to a system for post-disaster power restoration in a power grid. The system for post-disaster power restoration system in the power grid includes a microgrid controller, a refueling vehicle, load node devices and gas turbines, where the microgrid controller is configured to acquire related data of a disaster-affected area, generate an optimal control instruction and send the control instruction to the refueling vehicle to control the refueling vehicle in providing fuel for the gas turbines, thereby ensuring continuous operation of the gas turbines to supply power to the load node devices in the power grid in the disaster-affected area.

Specifically, the generation process of the control instruction in the method for post-disaster power restoration in the power grid illustrated in the present disclosure may be implemented on the microgrid controller or a server. By integrating physical information of the gas turbine nodes, the refueling vehicle and the disaster-affected power grid, the control instruction is generated to control the system for post-disaster power restoration in the power grid, thereby optimizing the control of power grid restoration. The method includes the following steps 101 to 104.

In step 101, the target data of the disaster-affected area is acquired.

The disaster-affected area may be a city that has suffered from a natural disaster (such as an earthquake, a typhoon or hail that may impact infrastructure, as mentioned in the present disclosure) or a key area within a city that has been affected by a natural disaster. If the method for post-disaster power restoration in the microgrid provided by the embodiments of the present disclosure needs to be implemented in the disaster-affected area, various data of the disaster-affected area needs to be collected first to enable a computer device to optimize the control of power grid restoration based on the collected data.

Specifically, the system collects the target data of the disaster-affected area by means of a power grid monitoring unit and a road monitoring unit, and the target data includes, but is not limited to, topological data of the power grid in the disaster-affected area, gas turbine data, load data, road data, the state of refueling vehicles in the disaster-affected area and the location of grid faults.

Since the topological data of the power grid is generally stable, and the topology of the power grid in a city does not change significantly over a short period, so the topological data of the power grid may be pre-acquired by staff from a power management organization of the disaster-affected area and pre-stored in the microgrid controller. From the topological data of the power grid, various nodes of the power grid in the disaster-affected area may be identified, including load nodes and gas turbine nodes. The load nodes represent that load node devices are installed at these nodes of the power grid, and the load node devices are configured to consume electrical power to perform corresponding functions (such as related devices in a hospital and related devices in a road traffic control system), i.e., representing that the power grid needs to output corresponding power from these nodes. The gas turbine nodes represent that the power grid is electrically connected to the gas turbines through these nodes, and the power grid may receive power supplied by the gas turbines under disaster conditions.

In the present disclosure, the gas turbine data includes equipment states and spatial location of the gas turbines. Since the operation of the gas turbines requires sufficient fuel when collecting data, it is necessary not only to collect the equipment state of the gas turbine at each gas turbine node (such as the fuel reserve, historical consumption and output power of the gas turbines), but also to collect the spatial location of the gas turbine node for subsequent planning of fuel delivery for each gas turbine node. Correspondingly, in the embodiments of the present disclosure, the load data includes power data and spatial location of the load node device corresponding to each load node.

Further, fuel delivery for the gas turbine nodes is generally achieved by the refueling vehicle. To implement the solution provided by the present disclosure, one or more refueling vehicles need to be prepared in the key area of the city. The method of the present disclosure, when, implemented, also requires continuously acquiring the state of the refueling vehicles in the disaster-affected area (i.e., location and speed information, used to represent the location of the refueling vehicles and whether the refueling vehicles are in motion). When the key area is not affected by a disaster, the refueling vehicles may initially stay at a specific site. When the key area becomes a disaster-affected area, the refueling vehicles may operate among the gas turbine nodes and fuel supply sites to continuously deliver fuel to the gas turbines. Optionally, the refueling vehicle can be equipped with a positioning system, a fuel level sensor and a communication device to report its location information and fuel state to the microgrid controller in real time.

If the key area in the city is affected by a disaster, roads in the key area are usually affected as well. Therefore, to ensure that the refueling vehicles can provide fuel to the gas turbines in the disaster-affected area normally, it is necessary to acquire the road traffic conditions in the disaster-affected area in real time to plan paths for the refueling vehicles. Specifically, the road traffic conditions may be requested from the local road traffic management department or from related road navigation software.

In addition, when the key area in the city is affected by a disaster, there are usually one or more fault points in the power grid, such as multiple circuits in the disaster-affected area being physically disconnected. Therefore, in order to improve the effectiveness of power restoration, it is also necessary to acquire the location of the fault point in the disaster-affected area from a power management department, thereby determining a faulty line in the topology of the power grid and facilitating subsequent planning of power transmission paths from the gas turbine nodes to the load nodes.

In step 102, the overall constraints is constructed based on the relationship between the output power of gas turbine and its fuel consumption, as well as the correlation between the fuel delivery amount and the travel status of the refueling vehicle.

In the embodiments of the present disclosure, power restoration for the load nodes in the disaster-affected area needs to be achieved as much as possible, which is directly related to how the gas turbines generate power. However, the power output of the gas turbines is not unrestrained and is subject to limitations based on the operating status and allowable fuel consumption of the gas turbines, and fuel may be continuously supplied by the operation of the refueling vehicles. It thus can be seen that there is a close relationship between the output power of gas turbines, the fuel consumption of gas turbines and the travel status of refueling vehicles during the process of supplying power to the load nodes. Therefore, based on the above-mentioned logic, constraints can be constructed between various physical quantities involved in the present disclosure according to restrictions abided by the gas turbines in an actual operating environment, reflecting the objective conditions that need to be satisfied to restore power supply to the load nodes as much as possible in the presented solution of the present disclosure.

In step 103, the following variables are determined based on the target data and subject to the overall constraint, with an objective of maximizing the weighted load restoration during the fault duration: the travel trajectory of refueling vehicles and their fuel delivery amount at each gas turbine node, the output power of each gas turbine, and the load restoration amount of each load node.

The weighted load restoration is defined as the weighted sum power supplied to all load nodoes throughout the fault, where each load node has a corresponding load weight.

The microgrid controller, subject to the overall constraint condition, aims to maximize the weighted load restoration during the fault duration as the power restoration objective. The weighted load restoration is defined as the weighted sum power supplied to all load nodoes throughout the fault, where each load node has a corresponding load weight. The load weight may be predefined by developers for each load node, for example, more important load nodes (such as hospitals) may be assigned higher load weights to prioritize their power supply during the power restoration process.

The microgrid controller, based on the target data collected in step 101, determines the travel trajectory of refueling vehicles and the fuel delivery amount of the refueling vehicle at each gas turbine node by solving an optimization problem, maximizing the weighted load restoration.

The optimization process may be implemented on the microgrid controller or a computation server, using a mathematical planner to solve the problem with integer programming, liner programming or mixed integer linear programming (MILP) methods. The final solution obtained is the travel trajectory of the refueling vehicles and the fuel delivery amount of refueling vehicles at each gas turbine node. This is achieved through linear programming, calculating the travel trajectory of refueling vehicles on the roads and the fuel delivery amount of the refueling vehicle at each gas turbine node, thereby determining the optimal operating status of the gas turbine. This allows the power output of the gas turbine to efficiently and maximally meet the power demand of each load node.

In step 104, the operating status of each load node, the output power of gas turbines, and fuel delivery by refueling vehicles to each gas turbine node are controlled based on the travel trajectory of refueling vehicles, the fuel delivery amount of the refueling vehicle at each gas turbine node, the output power of each gas turbine and the load restoration amount of each load node.

Optionally, the microgrid controller may generate a refueling vehicle scheduling control instruction, a gas turbine scheduling instruction and a load node scheduling instruction based on the travel trajectory of the refueling vehicle on the roads in the disaster-affected area, the fuel delivery amount of the refueling vehicle at each gas turbine node (i.e., the amount of fuel provided by the refueling vehicle to the gas turbine at each gas turbine node in the power grid), the output power of each gas turbine and the load restoration amount of each load node, where the refueling vehicle scheduling control instruction includes the driving route, the departure time and the fuel delivery amount and the stop node of refueling vehicles.

The microgrid controller controls the output power of gas turbines according to the gas turbine scheduling instruction.

The microgrid controller controls the operating status and load restoration amount of the load nodes according to the load node scheduling instruction.

The microgrid controller controls the refueling vehicles according to the refueling vehicle scheduling control instruction to deliver fuel to each gas turbine node.

In short, since the output power of each gas turbine and the load restoration amount of each load node have been determined when the weighted load restoration is maximized in the aforementioned step, the embodiments of the present disclosure can generate corresponding control instructions according to the above calculation results to control the load nodes and the gas turbines.

Specifically, the output power of each gas turbine may be represented by time-series power data, which characterizes an output power value of each gas turbine at each time point. The microgrid controller may send the time-series power data to the gas turbine, so that the internal controller of the gas turbine can perform feedback control based on this data, ensuring that the power output of each gas turbine is in line with the time-series power data.

Specifically, the load restoration of each load node may also be represented by time-series restoration data, which characterizes the operable power of each load node at each time point. Each load node may determine whether to operate at each time point and the power level according to the time-series restoration data (i.e., the load restoration amount).

To ensure that the gas turbines can output power as planned, according to the travel status of refueling vehicles in the disaster-affected area and the fuel delivery amount of the refueling vehicle at each gas turbine node, the microgrid controller in the embodiments of the present disclosure will also generate the refueling vehicle scheduling control instruction, and the refueling vehicle scheduling control instruction includes the driving route, the departure time, the fuel delivery amount, and stop nodes of refueling vehicles. Then, the refueling vehicles are controlled according to the refueling vehicle scheduling control instruction to delivery fuel to each turbine node.

Specifically, the microgrid controller, after receiving the results from the mathematical planner (i.e., state variables and fuel operation variables of all refueling vehicles in all time steps), may generate corresponding time-series data for each refueling vehicle. In the embodiments of the present disclosure, the time-series data includes the expected travel path, the expected location and expected remaining fuel amount of each refueling vehicle at each time node. By analyzing the continuous time-series data, a sequence of target nodes that the refueling vehicles need to visit may be determined, and then combined with the road data of the disaster-affected area to plan the specific driving routes.

Further, by analyzing the time-series data of each refueling vehicle, the microgrid controller may also accurately calculate when the refueling vehicle should depart from its current location and the estimated time of arrival at each target node. Then, the microgrid controller binds the fuel operation variables to corresponding nodes and times, so that the refueling vehicle performs a specific action at a specific time when it arrives at a particular node (for example, at a time point T, the refueling vehicle 1 unloads 150 liters of fuel at a node C).

The refueling vehicle may receive the control instruction via wire communication interface and feedback its real-time location and fuel status, so as to enable the system to perform closed-loop scheduling.

The overall constraints proposed in the step 102 may be constructed as follows:

The travel constraints of refueling vehicles are constructed, where the travel constraints of refueling vehicles are used for indicating a unique location of the refueling vehicle in the disaster-affected area at any time.

The fuel delivery constraints of refueling vehicles are constructed, where the fuel delivery constraints of refueling vehicles are used for presenting the variation in the fuel quantity of a refueling vehicle between any two consecutive time steps. This variation comprises the replenishment amount received by the vehicle and the fuel supply amount delivered when it passes through a gas turbine node.

The fuel consumption constraints of gas turbines are constructed, where the fuel consumption constraints of gas turbines are used for indicating the fuel consumption amount of each gas turbine between any two adjacent times.

The power constraints of gas turbines are constructed, where the power constraints are used for indicating the relationship between the power output of gas turbine and its fuel consumption amount.

The power flow constraints of the power grid are constructed, where the power flow constraints of the power grid are used for indicating the energy flow state between any two adjacent nodes, and the nodes include the gas turbine nodes and the load nodes.

Based on the relationship between the output power of gas turbine and its fuel consumption, as well as the correlation between the fuel delivery amount and the travel status of the refueling vehicle, The travel constraints of refueling vehicles, the fuel delivery constraints of refueling vehicles, the fuel delivery constraints of gas turbines, the power output constraints of gas turbines and the power flow constraints of the power grid are combined to generate the overall constraints.

In short, the overall constraints includes the travel constraints of refueling vehicles, the fuel delivery constraints of refueling vehicles, the fuel delivery constraints of gas turbines and the power flow constrints of the power grid.

The travel constraints of refueling vehicles are configured to constrain each refueling vehicle to move according to the physical motion law, and to ensure that each refueling vehicle can only be in one unique location at any given time, thereby ensuring that the travel of each refueling vehicle consistent with practical operations.

Optionally, in the embodiments of the present disclosure, there are fuel replenishment nodes and fuel delivery nodes on the roads in the disaster-affected area, where the fuel replenishment nodes indicate areas where fuel is stored in the disaster-affected area, while the fuel delivery nodes indicate actual locations of the gas turbines deployed in the power grid within the disaster-affected area.

The fuel delivery constraints of refueling vehicles characterize that, during the movement of a refueling vehicle, its fuel supply amount can only be increased when it passes through a fuel replenishment node, and fuel can only be delivered to the gas turbines (i.e., supplying fuel to the gas turbines) when it passes through a gas turbine node.

The fuel consumption constraints of gas turbines represent the fuel consumption amount of gas turbines between two time steps, which is related to whether there is sufficient fuel consumption and whether a refueling vehicle provides the fuel supply.

The power constraints of gas turbines represent the amount of power that can be provided by fuel consumption amount of the gas turbine between two time steps.

The power flow constraints of the power grid represent the lines through which the power supplied by the gas turbines can be transmitted, as well as the load nodes that can be reached via these lines, in accordance with the current damage status of the power grid.

It can be concluded from the above constraints that all the constraints are closely interrelated. The energy flow state of power supply from the gas turbine nodes to the load nodes must be correlated with the power of the gas turbine nodes; the power of the gas turbine nodes must be correlated with the fuel consumption of the gas turbines; the fuel consumption of the gas turbines must be correlated with the remaining fuel amount of the gas turbines between two time steps and whether the refueling vehicles have delivered fuel; and the fuel delivery of the refueling vehicles to each gas turbine must be correlated with the travel status of the refueling vehicles. Therefore, all the above constraints are constructed based on the actual conditions during the power grid restoration process. Each constraint must conform to the corresponding physical laws, and these physical laws are interrelated with one another, thereby enabling the overall constraints to accurately represent the physical environment of the current disaster-affected area.

The specific construction method and physical meaning of each constraint is introduced in detail below.

In the embodiments of the present disclosure, the travel constraints of refueling vehicles includes:
firstly, the travel status of the refueling vehicle satisfies the following first constraint:

$$\{ \begin{matrix}{α}_{f . t} \geq {\sum }_{n ∈ {N}_{M}} {v}_{f . n . t - 1} + {\sum }_{n ∈ {N}_{M}} {v}_{f . n . t} - 2 + ε \\ - ( 1 - {α}_{f . t} ) \leq {v}_{f . n . t} - {v}_{f . n . t - 1} \leq ( 1 - {α}_{f . t} )\end{matrix} , f ∈ F , n ∈ {N}_{M} , t ∈ T$$

where N_{M} is the set of nodes in a traffic network (in the embodiments of the present disclosure, the traffic network is a topological diagram constructed based on the road data of the disaster-affected area, including the fuel replenishment nodes and the fuel delivery nodes); F is the set of the refueling vehicles; T is the set of scheduling time scales, which can be estimated according to the disaster situation; ν_{f.n.t} and ν_{f.n.t-1} both are binary variables indicating whether refueling vehicle f is located at node n at time step t and time step t−1; e is a small positive constant; a_{f.t} is a binary variable that indicate whether the refueling vehicle f is in the travle state between time step t−1 and time step t. The first constraint indicates that for a certain refueling vehicle f at a certain time, its travle state must be either stationary at the node n or heading to the node n.

The refueling vehicle satisfies the following second constraint between the stationary status and the travel status:

$${\sum }_{n ∈ {N}_{M}} {x}_{f . n . t} + {\sum }_{n ∈ {N}_{M}} {v}_{f . n . t} = 1 , f ∈ F , t ∈ T$$

where x_{f.n.t} is a binary variable indicating whether the refueling vehicle f stops at node n at time step t. The second constraint represents that each refueling vehicle can only be in one state at each time.

The transition between the stationary status and the travel status of refueling vehicles satisfies the following third constraint:

$$\{ \begin{matrix}{x}_{f . n . t + 1} \geq {x}_{f . n . t} + 1.2 ( {v}_{f . n . t} - {v}_{f . n . t + 1} ) + 0.4 ( {\sum }_{n ∈ {N}_{M}} {v}_{f . n . t} - {\sum }_{n ∈ {N}_{M}} {v}_{f . n . t + 1} ) - 0.8 \\ {x}_{f . n . t + 1} \leq {x}_{f . n . t} + ( {v}_{f . n . t} - {v}_{f . n . t + 1} ) - 0.5 ( {\sum }_{n ∈ {N}_{M}} {v}_{f . n . t} - {\sum }_{n ∈ {N}_{M}} {v}_{f . n . t + 1} ) + 0.7\end{matrix} , f ∈ F , n ∈ {N}_{m} , t ∈ T \backslash \{ D \}$$

where the third constraint represents that the travel status of the refueling vehicle can be updated at time step t+1 according to its speed at time step t, the speed at time step t+1 and the travel status at time step t.

The travel status of the refueling vehicle is subject to the following fourth constraint:

$${R}_{f , t} / ϕ \leq {\sum }_{n ∈ {N}_{M}} {v}_{f , n , t} \leq {R}_{f , t} , f ∈ F , t ∈ T$$

where, R_{f.t} indicates the residual travel time of the refueling vehicle f at time step t, and φ is a large constant. The fourth constraint is configured to relate the travel status (i.e., whether the refueling vehicle f is heading to node n) of the refueling vehicle f at time step t to its residual travel time R_{f.t}. Specifically, when the refueling vehicle is moving, the residual travel time R_{f.t} must satisfy R_{f.t}/φ≤1≤R_{f.t}, that is, R_{f.t}≥1 and R_{f.t}≤φ. Therefore, the vehicle can only move when the residual time is at least 1, and the residual time cannot exceed the constant φ when moving.

The residual travel time of refueling vehicles satisfies the following fifth constraint:

$$\{ \begin{matrix}{R}_{f \text{.1}} = {C}_{f \text{.1}} , f ∈ F \\ {R}_{f . t} = {R}_{f . t - 1} + {C}_{f . t} - {\sum }_{n ∈ {N}_{M}} {v}_{f . n . t - 1} , f ∈ F , t ∈ T ∖ \{ 1 \}\end{matrix}$$

where R_{f.t} indicates the residual travel time of the refueling vehicle f at time step t, and R_{f.1} indicates the residual travel time of the refueling vehicle f at the first time step; C_{f.t} indicates the number of time steps still required by the refueling vehicle f to move at time step t, and C_{f.1} indicates the number of time steps still required by the refueling vehicle f to move at the first time step.

The fifth constraint specifically defines how the residual travel time R_{f.t} of the refueling vehicle f changes over time. Specifically, at the initial time step t=1, the residual travel time R_{f.t} is directly equal to the initially required operating time C_{f.1} that is, the residual travel time of the vehicle at the beginning is determined by the initial task. For subsequent t≥2, the residual travel time R_{f.t} consists of three parts: the residual travel time from the previous time step, the number of time steps required to be consumed at the current time step t and consumption of the travel status at the previous time step t−1. Therefore, the residual travel time at each time step inherits the residual time from the previous time step, adds the newly required operating time and subtracts the travel consumption of the previous time step, thereby simulating the time accumulation and consumption process of the residual time of refueling vehicle during actual operation, ensuring that the travel progress of the vehicle is synchronized with time.

The travel time required by the refueling vehicle at each time satisfies the following sixth constraint:

$$\{ \begin{matrix}{C}_{f \text{.1}} \geq \sum {v}_{f . {n}^{′} \text{.1}} {T}_{f . {nn}^{′}} , f ∈ F , n ∈ {N}_{M} \\ \begin{matrix}{C}_{f . t} \geq {x}_{f . n . t - 1} {\sum }_{{n}^{′} ∈ {N}_{M}} {T}_{f . {nn}^{′}} + {\sum }_{{n}^{′} ∈ {N}_{M}} {v}_{f . {n}^{′} . t} {T}_{f , {nn}^{′}} - {\sum }_{{n}^{′} ∈ {N}_{M}} {T}_{f , {nn}^{′}} , \\ f ∈ F , n ∈ {N}_{M} , t ∈ T ∖ \{ 1 \}\end{matrix} \\ {C}_{f . t} \geq 0 , f ∈ F , t ∈ T\end{matrix}$$

where ν_{f.n′.1} indicates whether refueling vehicle f is located at node n′ at the first time step, and ν_{f.n′t} indicates whether refueling vehicle f is located at node n′ at time step t; T_{f.nn′} indicates the number of time steps required for refueling vehicle f to move from node n to node n′.

The sixth constraint defines the lower limit of the travel time C_{f.t} required by the refueling vehicle f at time step t. If the vehicle is moving at the first time step, then C_{f.1} is at least equal to the travel time required to reach node n′, thereby ensuring that the initially required time covers the travel cost. For t≥2, if the vehicle is moving at time step t−1, then C_{f.t} is at least equal to the travel time required to reach the target node. If the vehicle is moving at time step t−1, then C_{f.t} needs to substrate the time for the vehicle f to move towards node n′, but C_{f.t} must not be less than 0.

Further, the fuel delivery constraints of refueling vehicles include:

$${S}_{f . t}^{F} = {S}_{f . t - 1}^{F} + {V}_{f . t} - {\sum }_{n ∈ {N}_{M}} {U}_{f . n . t} , f ∈ F , t ∈ T$$

$$0 \leq {U}_{f . n . t} \leq {x}_{f . n . t} {W}_{f}^{F} , f ∈ F , n ∈ {N}_{M} , t ∈ T$$

$$0 \leq {V}_{f . t} \leq {x}_{f . n = k . t} {W}_{f}^{F} , f ∈ F , t ∈ T$$

where

$${S}_{f . t}^{F} and {S}_{f . t - 1}^{F}$$

respectively indicate remaining fuel amounts of refueling vehicle f at time step t and at time step t−1; N_{M} is the set of nodes in a traffic network; V_{f.t} indicates a fuel replenishment amount of refueling vehicle f at time step t; U_{f.n.t} indicates fuel delivery amount of refueling vehicle f at node n at time step t;

$${W}_{f}^{F}$$

indicates the fuel loading capacity of refueling vehicle f; x_{f.n=k.t} is a binary variable that indicates whether refueling vehicle f stops at the node where a refueling station is located at time step t, i.e., n=k.

The above fuel delivery constraints of refueling vehicles limits the relationship between the remaining fuel amount of the refueling vehicle f at time step t and at time step t−1, the fuel replenishment amount of refueling vehicle f at time step t and the fuel delivery amount of refueling vehicle fat time step t. In addition, it is also stipulated that the refueling vehicle only supplies fuel to the power grid nodes and cannot extract fuel from the nodes. A refueling vehicles must be stationary at node n to supply fuel at node n, and the supply amount of the refueling vehicle at node n cannot exceed its total fuel tank capacity. The fuel delivery constraints of refueling vehicles ensure that the fuel status of the refueling vehicle satisfies the physical laws during the calculation process, and conforms to the fuel changes in practical applications.

The remaining fuel amount of refueling vehicles satisfies the following seventh constraint:

$$0 \leq {S}_{f . t}^{F} \leq {W}_{f}^{F} , f ∈ F , t ∈ T$$

Further, the fuel consumption constraints of gas turbines include:

the remaining fuel amount of the gas turbine satisfies the following eighth constraint:

$${S}_{g . t}^{G} = {S}_{g . t - 1}^{G} + {\sum }_{f ∈ F} {U}_{f . n = g . t} - {B}_{g . t} , g ∈ G , t ∈ T$$

where G is the set of gas turbines; T is the set of scheduling time scales;

$${S}_{g . t}^{G} and {S}_{g . t - 1}^{G}$$

respectively indicate the remaining fuel amount of gas turbine g at time step t and at time step t−1, U_{f.n=g.t} indicates the fuel delivery amount of refueling vehicle f at node n connected with gas turbine g at time step t, and B_{g.t} indicates the fuel consumption amount of gas turbine g at time step t.

The eighth constraint links the supplement decision U_{f.n=g.t} of the refueling vehicles and the power generation decision B_{g.t} of the gas turbines. If it is determined, according to the optimization algorithm, to increase the power generation of the gas turbines (increase B_{g.t}), enough refueling vehicles must be needed to deliver fuel in a timely manner (increase U_{f.n=g.t}); otherwise the inventory U_{f.n=g.t} will not be sufficient.

The fuel consumption amount of the gas turbine satisfies the following ninth constraint:

$${B}_{g . t} = {a}_{g . r} {P}_{g . t} + {b}_{g . r} , if {P}_{g . t} ∈ [ {p}_{g . r - 1} , {p}_{g . r} ]$$

where P_{g.t} indicates the active power output of gas turbine g at time step t; a_{g.r} is a coefficient of an r-th piecewise linear term of the fuel consumption function of gas turbine g; b_{g.r} is a coefficient of the r-th piecewise constant term of the fuel consumption function of gas turbine g; p_{g.r} is an r-th breakpoint of the fuel consumption function of gas turbine g, and p_{g.r} is an (r−1)-th breakpoint of the fuel consumption function of gas turbine g.

Since the efficiency of the gas turbine changes with the power output level, its fuel consumption curve is a convex function curve rather than a simple straight line. To maintain accuracy while making the model solvable, the convex function curve is approximated by multiple line segments that are connected end-to-end, such that the relationship between the active power output and the fuel consumption amount of the gas turbine is constructed by means of the ninth constraint, in which is a nonlinear function here. In the embodiments of the present disclosure, the coefficients a_{g.r} and b_{g.r} may be fitted according to the existing fuel consumption curve of the gas turbine, and different gas turbine models can fit different coefficients.

Further, the power output constrains of the gas turbine include:

$${P}_{g}^{G . min} \leq {P}_{g . t}^{G} \leq {P}_{g}^{G . max} , g ∈ G , t ∈ T$$

$${Q}_{g}^{G . min} \leq {Q}_{g . t}^{G} \leq {Q}_{g}^{G . max} , g ∈ G , t ∈ T$$

where

$${P}_{g . t}^{G}$$

indicates the active power output of gas turbine g at time step t;

$${Q}_{g . t}^{G}$$

indicates a reactive power output of the gas turbine g at time step t;

$${P}_{g}^{G . min} and {P}_{g}^{G . max}$$

respectively indicate the lower limit and the upper limit of the active power output of gas turbine g;

$${Q}_{g}^{G . min} and {Q}_{g}^{G . max}$$

indicate the lower limit and the upper limit of the reactive power output of gas turbine g, respectively; and G is the set of the gas turbines.

The above power constraints of the gas turbine limit physical and safety boundaries of the gas turbine, such that the active power output of the gas turbine at any time must be between technically allowed minimum and maximum power outputs, the reactive power output of the gas turbine at any time must also be within the technically allowed range, and the remaining fuel amount of the gas turbine cannot be negative and cannot exceed the allowed fuel storage upper limit.

Further, the power flow constraints of the power grid include:

$${\sum }_{h : ( h , i ) ∈ B} {p}_{hi . t}^{BR} = {\sum }_{j : ( i , j ) ∈ B} {p}_{ij . t}^{BR} + {P}_{i . t} - {P}_{i . t}^{G} , ∀ i ∈ N , ∀ t$$

$${\sum }_{h : ( h , i ) ∈ B} {q}_{hi . t}^{BR} = {\sum }_{j : ( i , j ) ∈ B} {q}_{ij . t}^{BR} + {Q}_{i . t} - {Q}_{i . t}^{G} , ∀ i ∈ N , ∀ t$$

$${Y}_{hi}^{P . min} \cdot {u}_{hi}^{B} \leq {p}_{hi . t}^{BR} \leq {Y}_{hi}^{P . max} \cdot {u}_{hi}^{B} , ∀ ( h , i ) ∈ B , ∀ t$$

$${Y}_{hi}^{Q . min} \cdot {u}_{ij}^{B} \leq {q}_{hi . t}^{BR} \leq {Y}_{hi}^{Q . max} \cdot {u}_{ij}^{B} , ∀ ( h , i ) ∈ B , ∀ t$$

where N is the set of nodes; B is the set of lines;

$${p}_{hi . t}^{BR} and {p}_{ij . t}^{BR}$$

respectively indicate the active power flowing through the line (h,i) and the line (i,j) at time step t;

$${q}_{hi . t}^{BR} and {q}_{ij . t}^{BR}$$

respectively indicate the reactive power flowing through the line (h,i) and the line (i,j) at time step t;

$${P}_{i . t}^{G}$$

indicates the active power output of the gas turbine connected at node i at time step t;

$${Q}_{i . t}^{G}$$

indicates a reactive power output of the gas turbine connected at node i at time step t; P_{i.t} indicates the active power restoration amount of the load at node i at time step t; Q_{i.t} indicates the reactive power restoration amount of the load on node i at time step t;

$${u}_{hi}^{B}$$

is used to characterize whether the line (h,i) is in the fault state,

$${u}_{hi}^{B} = 0$$

indicates the line is in the fault state, otherwise

$${u}_{hi}^{B} = 1 ; {u}_{ij}^{B}$$

is used to characterize whether the line (i,j) is in the fault state,

$${u}_{ij}^{B} = 0$$

indicates the line is in the fault state, otherwise

$${u}_{ij}^{B} = 1 ; {Y}_{hi}^{P . min}$$

indicates the minimum allowable active power through line (h,i);

$${Y}_{hi}^{P . max}$$

indicates the maximum allowable active power through line (h,i);

$${Y}_{hi}^{Q . min}$$

indicates the minimum allowable reactive power through line (h,i);

$${Y}_{hi}^{Q . max}$$

indicates the maximum allowable reactive power through line (h,i).

In the above power flow constraints of the power grid, both the active power and the reactive power are restrained based on the Kirchhoff's current law of the power network, that is, for each node, the sum of the active/reactive power flowing into the node at a certain time=the sum of the active/reactive power flowing out from the node to other nodes plus the active/reactive power consumed by the load at the node—the active/reactive power output by the gas turbine (if present) at the node.

In addition, the power flow constrains of the power grid also ensures that the power on each line is within the thermal stability limits and the technical operating range, and if a fault occurs, both the upper power flow limit and the lower power flow limit are set to 0, which does not allow the power to flow through the faulty line. Therefore, through the power flow constraints, the physical laws that each line and node satisfy during the optimization process are defined.

The overall constraints obtained from the integration of the above constraints are not idealized mathematical model, but are deeply embedded with physical laws of the real world. Based on the principles of fuel conservation for the refueling vehicles and gas turbines, and the principles of power conservation for the power grid, the physical limits of devices are set, the nonlinear characteristics of the gas turbines during actual operation are considered, and the risks of delays or interruptions in fuel supply caused by traffic are clearly considered. This proactively and optimally schedules the refueling vehicles to ensure that key gas turbines continue to operate. Then, through the strict power flow constraint, it ensures that the power grid does not experience line overloads during the restoration process, maintains power balance, and fundamentally prevents secondary failures caused by improper restoration strategies.

In an optional embodiment, in the above step 103, subject to the overall constraints and with the power restoration objective of maximizing the weighted load restoration amount during the fault duration, planning is performed by a mathematical planner to obtain the travel trajectory of the refueling vehicle on the roads in the disaster-affected area, the fuel delivery amount of the refueling vehicle at each gas turbine node, the output power of each gas turbine and the load restoration amount of each load node.

Specifically, the fuel consumption model of the gas turbine is linearized as follows:

$$\{ \begin{matrix}- ϕ ( 1 - {τ}_{g . t . r} ) \leq {B}_{g . t} - ( {a}_{g . r} {P}_{g . t} + {b}_{g . r} ) \\ {B}_{g . t} - ( {a}_{g . r} {P}_{g . t} + {b}_{g . r} ) \leq ϕ ( 1 - {τ}_{g . t . r} ) \\ {p}_{g . r - 1} - {P}_{g . t} \leq ϕ ( 1 - {τ}_{g . t . r} ) \\ {P}_{g . t} - {p}_{g . r} \leq ϕ ( 1 - {τ}_{g . t . r} )\end{matrix} , ∀ g ∈ G , t ∈ T , r ∈ \{ 1 , 2 , … R \}$$

$${\sum }_{r ∈ \{ 1 , 2 , … R \}} {τ}_{g . t . r} = 1$$

where φ is a constant; τ_{g.t.r} is a binary variable that indicates whether the power output of gas turbine g is within the interval [p_{g.r-1}, p_{g.r}] at time step t; R indicates the total number of breakpoints.

The original ninth constraint is a nonlinear constraint, which is difficult for a linear programming solver to handle. Therefore, a set of switch constraints needs to be created for each segment r in the embodiments of the present disclosure. The above linearization process requires the solver to select and only select one segment r for each gas turbine at each time step t; once each segment r is selected, a corresponding consumption formula is activated, using the corresponding upper and lower power output limits, and the constraints of other unselected segments r become ineffective and do not interfere with the solution.

After the aforementioned linearization, the overall constraints are constructed as linearized constraints. By using an existing mathematical planner (optionally, the mathematical planner is one of an integer planner, a liner planner or a mixed integer linear planner), upon collection of determined target data, the data can be substituted into the overall constraints to obtain the travel trajectory of refueling vehicles on roads in the disaster-affected area and the fuel delivery amount of the refueling vehicles at the gas turbine node, with the weighted load restoration amount during the fault duration maximized. When the travel trajectory and the fuel delivery amount are obtained, the movement of the refueling vehicle and the provision of fuel to each gas turbine can be indicated through the travel trajectory.

To sum up, the present disclosure takes the travel status, path and fuel delivery action of the refueling vehicle as core decision variables. Through the overall constraints, the traffic network, the fuel supply network and the power grid are coupled, and with the objective of maximizing the weighted load restoration, an optimal solution considering the traffic network, the fuel supply network and the power grid is obtained, thereby controlling the output power of gas turbines and the operating status of load nodes; then, energy is actively supplied to the gas turbine by accurately calculating the travel status, path and fuel delivery action of the refueling vehicle, ensuring that key power generation resources can continuously receive fuel throughout the entire duration of a fault. This greatly improves the reliability and sustainability of the power restoration plan.

In one embodiment, a computer device is provided. The computer device includes a memory, a processor, and a computer program stored in the memory and executable on the processor, where the processor, when executing the computer program, implements the following:

acquiring the target data of the disaster-affected area. In this area, there exist gas turbine nodes and load nodes. The gas turbine nodes are designed to supply power via gas turbines under disaster conditions. The target data includes road data of the disaster-affected area, topological data of the power grid, the state of refueling vehicles in the disaster-affected area and the location of grid faults;

constructing overall constraints based on the relationship between the output power of gas turbine and its fuel consumption, as well as the correlation between the fuel delivery amount and the status of the refueling vehicle;

determining the following variables based on the target data and subject to the overall constraint with aa objective of maximizing the weighted load restoration during the fault duration: the travel trajectory of refueling vehicles and their fuel delivery amount at each gas turbine node, the output power of each gas turbine, and the load restoration amount of each load node. Herein, the weighted load amount is calculated as the weighted sum power supplied to all load nodoes throughout the fault, where each load node has a corresponding load weight; and

Controlling the fuel delivery by refueling vehicles to each gas turbine node based on the travel trajectory of refueling vehicles, and the fuel delivery amount of the refueling vehicle at each gas turbine node.

For the specific limitations of each step, reference may be made to the limitations of the method for post-disaster power restoration in the power grid described above, which will not be repeated here.

In one embodiment, a computer-readable storage medium is provided. The computer-readable storage medium stores a computer program, and the computer program, when executed by a processor, implements the following:

acquiring the target data of the disaster-affected area. In this area, there exist gas turbine nodes and load nodes. The gas turbine nodes are designed to supply power via gas turbines under disaster conditions. The target data includes road data of the disaster-affected area, topological data of the power grid, the state of refueling vehicles in the disaster-affected area and the location of grid faults;

constructing overall constraints based on the relationship between the output power of gas turbine and its fuel consumption, as well as the correlation between the fuel delivery amount and the status of the refueling vehicle;

determining the following variables based on the target data and subject to the overall constraint with aa objective of maximizing the weighted load restoration during the fault duration: the travel trajectory of refueling vehicles and their fuel delivery amount at each gas turbine node, the output power of each gas turbine, and the load restoration amount of each load node. Herein, the weighted load amount is calculated as the weighted sum power supplied to all load nodoes throughout the fault, where each load node has a corresponding load weight; and

controlling the fuel delivery by refueling vehicles to each gas turbine node based on the travel trajectory of refueling vehicles, and the fuel delivery amount of the refueling vehicle at each gas turbine node.

For the specific limitations of each step, reference may be made to the limitations of the method for post-disaster power restoration in the power grid described above, which will not be repeated here.

As a specific example, in one embodiment, the present disclosure is further verified and described in detail.

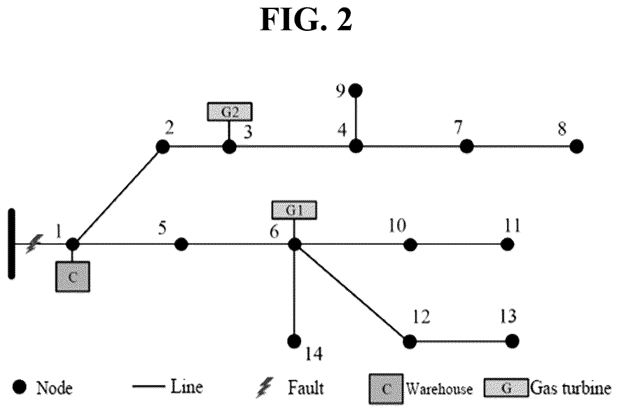

Using an improved IEEE14 node test system as an example, the effectiveness of the method for post-disaster power restoration in the power grid provided by the present disclosure is verified. The topology of a power grid is shown in FIG. 2.

Assuming that the microgrid has lost power supply from the main grid due to an extreme natural disaster. The microgrid is equipped with two gas turbines, G1 and G2, with fuel tank capacities of of 600 L and 400 L respectively. The hourly fuel consumption amount of the gas turbine G1 at ¼ rated power, ½ rated power, ¾ rated power and full load is 60 L, 180 L, 360 L and 600 L respectively. The hourly fuel consumption amount of the gas turbine G2 at ¼ rated power, ½ rated power, ¾ rated power and full load is 25 L, 100 L, 225 L and 400 L respectively. Other parameters of the gas turbines are shown in Table 1. In addition, the system is also equipped with a refueling vehicle.

TABLE 1
Parameters of gas turbines

| Power | | | | Initial remaining fuel |
|---|---|---|---|---|
| supply | Node | P_{g}^{G.max} (kW) | Q_{g}^{G.max} (kVar) | amount |
| G1 | 6 | 300 | 280 | 120 L |
| G4 | 3 | 200 | 200 | 80 L |

In the decision-making process for the power restoration solution, the variables and constraints need to be defined for each time step. Therefore, the selection of the number of time steps will affect the efficiency of power restoration decisions. In a case where the number of time steps is too small, it may lead to the generation of a locally optimal solution. When the time-step duration is too large, it will slow down the computational speed. In this example, it is assumed that the interval between two consecutive time steps in the sequential restoration process is set to 30 min, with a total restoration time of 8 time steps.

Through optimization decision-making, the travel trajectory of the refueling vehicle is obtained, as shown in Table 2 below. The refueling vehicle departs from the warehouse (node 1), arrives at node 6 at the third time step to deliver fuel to the gas turbine G1, returns to the warehouse to receive fuel at the fifth time step, and arrives at node 3 at the seventh time step to deliver fuel to the gas turbine G2.

TABLE 2
Travel trajectory of the refueling vehicle

| Time steps | 1 | 2 | 3 | 4 | 5 | 6 | 7 | 8 |
|---|---|---|---|---|---|---|---|---|
| Location of the | 1 | 1→6 | 6 | 6→1 | 1 | 1→3 | 3 | 3 |
| refueling vehicle | | | | | | | | |

The method for post-disaster power restoration in the power grid proposed by the present disclosure considers the fuel supply elasticity. To illustrate the advantages of the proposed method, this example compares the strategy for power restoration in microgrid that considers the fuel supply elasticity with a traditional strategy for power restoration that does not consider the fuel supply elasticity.

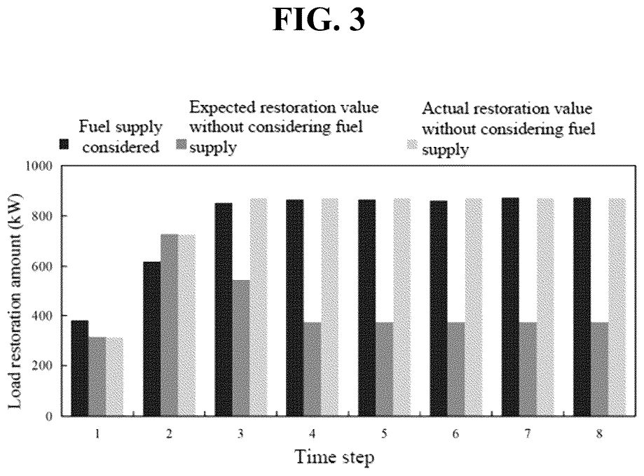

FIG. 3 illustrates expected load restoration amount and actual load restoration amount under the two approaches for power restoration. The expected load restoration amount is the restoration amount obtained through model optimization, and the actual restoration amount is the load restoration amount taking into the account the remaining fuel constraint of the gas turbine. Since the proposed method considers the remaining fuel limitations of the gas turbine, the actual load restoration amount in the proposed method is equivalent to the expected load restoration amount.

As can be seen from FIG. 3, although the power restoration model that does not consider fuel supply elasticity can achieve a better objective function, there is a significant deviation between the actual load restoration situation and the expected load restoration situation. When the remaining fuel of the gas turbine is exhausted, the gas turbine will exit operation, leading to a large number of secondary power outages. Therefore, the proposed strategy for power restoration that considers the fuel supply elasticity can effectively ensures continuous and reliable operation of the gas turbine, thereby improving the reliability of the plan for post-disaster power restoration in the power grid.

The above embodiments show and describe the basic principles and main features of the present disclosure. Those skilled in the art should understand that the present disclosure is not limited to the above embodiments, and the above embodiments and the descriptions in the specification are merely for the principle of the present disclosure. Various transformations and improvements may be made to the present disclosure without departing from the spirit and scope of the present disclosure, and all these transformations should fall within the protection scope of the present disclosure.

What is claimed is:

1. A method for post-disaster power restoration in a power grid, comprising:
acquiring the target data of the disaster-affected area, wherein gas turbine nodes and load nodes exist in the power grid, the gas turbine nodes are designed to supply power via gas turbines under disaster conditions, and the target data comprises topological data of the power grid in the disaster-affected area, gas turbine data, load data, road data, the state of refueling vehicles in the disaster-affected area, and the location of grid faults;
constructing overall constraints based on the relationship between the output power of gas turbine and its fuel consumption, as well as the correlation between the fuel delivery amount and the travel status of the refueling vehicle;
determining the following variables based on the target data and subject to the overall constraints with an objective of maximizing the weighted load restoration during the fault duration: the travel trajectory of refueling vehicles and their fuel delivery amount at each gas turbine node, the output power of each gas turbine, and the load restoration amount of each load node, wherein the weighted load amount is calculated as the weighted sum power supplied to all load nodoes throughout the fault, and each load node has a corresponding load weight; and
controlling the operating status of the load nodes and the output power of gas turbines, and the fuel delivery by refueling vehicles to each gas turbine node based on the travel trajectory of refueling vehicles, the fuel delivery amount of the refueling vehicle at each gas turbine node, the output power of each gas turbine and the load restoration amount of each load node.

2. The method according to claim 1, wherein constructing the overall constraints based on the relationship between the output power of gas turbine and its fuel consumption, as well as the correlation between the fuel delivery amount and the travel status of the refueling vehicle comprises:
constructing the travel constraints of refueling vehicles, wherein the travel constraints of refueling vehicles are used for indicating a unique position of the refueling vehicle in the disaster-affected area at any time;
constructing the fuel delivery constraints of refueling vehicles, wherein the fuel delivery constraints of refueling vehicles are used for presenting the variation in the fuel quantity of a refueling vehicle between any two consecutive time steps, and the variation comprises the replenishment amount received by the vehicle and the fuel supply amount delivered when it passes through a gas turbine node;
constructing the fuel consumption constraints of gas turbines, wherein the fuel consumption constraints of gas turbines are used for indicating the fuel consumption amount of gas turbines between any two adjacent times;
constructing the power output constraints of gas turbines, wherein the power output constraints are used for indicating the relationship between the power output of gas turbine and its fuel consumption amount;
constructing the power flow constraints of the power grid, wherein the power flow constraints of the power grid are used for indicating the energy flow state between any two adjacent nodes, and the nodes comprise the gas turbine nodes and the load nodes; and
combining, according to the relationship between the output power of gas turbine and its fuel consumption, as well as the correlation between the fuel delivery amount and the travel status of the refueling vehicle, the travel constraints of refueling vehicles, the fuel delivery constraints of refueling vehicles, the fuel consumption constraints of gas turbines, the power output constraints of gas turbines and the power flow constraints of the power grid to generate the overall constraints.

3. The method according to claim 2, wherein the travel constraints of refueling vehicles comprises: the travel status of the refueling vehicle satisfies the following first constraint:
$$\{ \begin{matrix}{α}_{f . t} \geq {\sum }_{n ∈ {N}_{M}} {v}_{f . n . t - 1} + {\sum }_{n ∈ {N}_{M}} {v}_{f . n . t} - 2 + ε \\ - ( 1 - {α}_{f . t} ) \leq {v}_{f . n . t} - {v}_{f . n . t - 1} \leq ( 1 - {α}_{f . t} )\end{matrix} , f ∈ F , n ∈ {N}_{M} , t ∈ T$$
where N_{M} is the set of nodes in a traffic network; F is the set of the refueling vehicles; T is the set of scheduling time scales; ν_{f.n.t} and ν_{f.n.t-1} are binary variables indicating whether refueling vehicle f is located at node n at time step t and time step t−1; ε is a small positive constant; a_{f.t} is a binary variable that indicate whether the refueling vehicle f is in the travle state between time step t−1 and time step t;
wherein the refueling vehicle satisfies the following second constraint between the stationary status and the travel state:
$${\sum }_{n ∈ {N}_{M}} {x}_{f . n . t} + {\sum }_{n ∈ {N}_{M}} {v}_{f . n . t} = 1 , f ∈ F , t ∈ T$$
where x_{f.n.t} is a binary variable indicating whether the refueling vehicle f stops at node n at time step t;
the transition between the stationary status and the travel e of refueling vehicles satisfies the following third constraint:
$$\{ \begin{matrix}{x}_{f . n . t + 1} \geq {x}_{f . n . t} + 1.2 ( {v}_{f . n . t} - {v}_{f . n . t + 1} ) + \\ 0.4 ( {\sum }_{n ∈ {N}_{M}} {v}_{f . n . t} - {\sum }_{n ∈ {N}_{M}} {v}_{f . n . t + 1} ) - 0.8 \\ {x}_{f . n . t + 1} \leq {x}_{f . n . t} + ( {v}_{f . n . t} - {v}_{f . n . t + 1} ) - \\ 0.5 ( {\sum }_{n ∈ {N}_{M}} {v}_{f . n . t} - {\sum }_{n ∈ {N}_{M}} {v}_{f . n . t + 1} ) + 0.7\end{matrix} , f ∈ F , n ∈ {N}_{M} , t ∈ T \backslash \{ D \}$$
the travel status of the refueling vehicle is subject to the following fourth constraint:
$${R}_{f . t} / ϕ \leq {\sum }_{n ∈ {N}_{M}} {v}_{f . n . t} \leq {R}_{f . t} , f ∈ F , t ∈ T$$
where R_{f.t} indicates the residual travel time of the refueling vehicle f at time step t, and φ is a large constant;
the residual travel time of refueling vehicles satisfies the following fifth constraint:
$$\{ \begin{matrix}{R}_{f \text{.1}} = {C}_{f \text{.1}} , & f ∈ F \\ {R}_{f . t} = {R}_{f . t - 1} + {C}_{f . t} - {\sum }_{n ∈ {N}_{M}} {v}_{f . n . t - 1} , & f ∈ F , t ∈ T \backslash \{ 1 \}\end{matrix}$$
where R_{f.t-1} indicates the residual travel time of refueling vehicle f at time step t−1, and R_{f.1} represents the residual travel time of refueling vehicle f at the first time step;
calculating the travel time required for the refueling vehicle at each time satisfies the following sixth constraint:
$$\{ \begin{matrix}{C}_{f \text{.1}} \geq {\sum }_{{n}^{′} ∈ {N}_{M}} {v}_{f . {n}^{′} \text{.1}} {T}_{f . {nn}^{′}} , & f ∈ F , n ∈ {N}_{M} \\ {C}_{f . t} \geq {x}_{f . n . t - 1} {\sum }_{{n}^{′} ∈ {N}_{M}} {T}_{f . {nn}^{′}} + & f ∈ F , n ∈ {N}_{M} , t ∈ T \backslash \{ 1 \} \\ {\sum }_{{n}^{′} ∈ {N}_{M}} {v}_{f . {n}^{′} . t} {T}_{f , {nn}^{′}} - {\sum }_{{n}^{′} ∈ {N}_{M}} {T}_{f . {nn}^{′}} , & \\ {C}_{f . t} \geq 0 , & f ∈ F , t ∈ T\end{matrix}$$
where ν_{f.n′.1} indicates whether refueling vehicle f is located at node n′ at the first time step, ν_{f.n′.t} indicates whether refueling vehicle f is located at node n′ at time step t, C_{f.t} indicates the travel time to be consumed by refueling vehicle f at time step t, and C_{f.1} indicates the travel time to be consumed by refueling vehicle f at the first time step; T_{f.nn′} indicates the number of time steps required for refueling vehicle f to move from node n to node n′.

4. The method according to claim 2, wherein the fuel delivery constraints of refueling vehicles comprise:
$${S}_{f . t}^{F} = {S}_{f . t - 1}^{F} + {V}_{f . t} - {\sum }_{n ∈ {N}_{M}} {U}_{f . n . t} , f ∈ F , t ∈ T$$
$$0 \leq {U}_{f . n . t} \leq {x}_{f . n . t} {W}_{f}^{F} , f ∈ F , n ∈ {N}_{M} , t ∈ T$$
$$0 \leq {V}_{f . t} \leq {x}_{f . n = k . t} {W}_{f}^{F} , f ∈ F , t ∈ T$$
where
$${S}_{f . t}^{F} and {S}_{f . t - 1}^{F}$$
indicate the remaining fuel amount of refueling vehicle f at time step t and at time step t−1, respectively; F is the set of the refueling vehicles; T is the set of scheduling time scales; N_{M} is the set of nodes in a traffic network; V_{f.t} indicates a fuel replenishment amount of refueling vehicle f at time step t; U_{f.n.t} indicates the fuel delivery amount of refueling vehicle fat node n at time step t;
$${W}_{f}^{F}$$
indicates the fuel loading capacity of refueling vehicle f x_{f.n=k.t} is a binary variable that indicates whether refueling vehicle f stops at the node, where a refueling station is located, at t time step t, i.e., n=k; and
the remaining fuel amount of refueling vehicles satisfies the following seventh constraint:
$$0 \leq {S}_{f . t}^{F} \leq {W}_{f}^{F} , f ∈ F , t ∈ T .$$

5. The method according to claim 2, wherein the fuel consumption constraints of gas turbines comprise:
the remaining fuel amount of the gas turbine satisfies the following eighth constraint:
$${S}_{g . t}^{G} = {S}_{g . t - 1}^{G} + {\sum }_{f ∈ F} {U}_{f . n = g . t} - {B}_{g . t} , g ∈ G , t ∈ T$$
where G is the set of the gas turbines; T is the set of scheduling time scales;
$${S}_{g . t}^{G} and {S}_{g . t - 1}^{G}$$
indicate the remaining fuel amount of gas turbine g at time step t and at time step t−1, respectively, U_{f.n=g.t} indicates the fuel delivery amount of refueling vehicle f at node n connected with gas turbine g at time step t, and B_{g.t} indicates the fuel consumption amount of gas turbine g at time step t; and
the fuel consumption mount of the gas turbine satisfies the following ninth constraint:
$${B}_{g . t} = {a}_{g . r} {P}_{g . t} + {b}_{g . r} , if {P}_{g . t} ∈ [ {p}_{g . r - 1} , {p}_{g . r} ]$$
where B_{g.t} indicates the fuel consumption amount of gas turbine g at time step t; P_{g.t} indicates the active power output of gas turbine g at time step t; a_{g.r} is a coefficient of an r-th piecewise linear term of the fuel consumption function of gas turbine g; b_{g.r} is a coefficient of the r-th constant term of the fuel consumption function of gas turbine g; p_{g.r} is an r-th breakpoint of the fuel consumption function of gas turbine g, and p_{g.r-1} is an (r−1)-th breakpoint of the fuel consumption function of gas turbine g.

6. The method according to claim 2, wherein the power output constraints of gas turbines comprise:
$${P}_{g}^{G . min} \leq {P}_{g . t}^{G} \leq {P}_{g}^{G . max} , g ∈ G , t ∈ T$$
$${Q}_{g}^{G . min} \leq {Q}_{g . t}^{G} \leq {Q}_{g}^{G . max} , g ∈ G , t ∈ T$$
where G is the set of the gas turbines, and
$${P}_{g . t}^{G}$$
indicates the active power output of gas turbine g at time step t;
$${Q}_{g . t}^{G}$$
indicates the reactive power output of gas turbine g at time step t;
$${P}_{g}^{G . m i n} and {P}_{g}^{G . ma x}$$
indicate the lower limit and the upper limit of the active power output of gas turbine g, respectively;
$${Q}_{g}^{G . m i n} and {Q}_{g}^{G . m ax}$$
indicate the lower limit and the upper limit of the reactive power output of gas turbine g, respectively.

7. The method according to claim 2, wherein the power flow constraints of the power grid comprise:
$${\sum }_{h : ( h , i ) ∈ B} {p}_{hi . t}^{BR} = {\sum }_{j : ( i , j ) ∈ B} {p}_{ij . t}^{BR} + {P}_{i . t} - {P}_{i . t}^{G} , ∀ i ∈ N , ∀ t$$
$${\sum }_{h : ( h , i ) ∈ B} {q}_{hi . t}^{BR} = {\sum }_{j : ( i , j ) ∈ B} {q}_{ij . t}^{BR} + {Q}_{i . t} - {Q}_{i . t}^{G} , ∀ i ∈ N , ∀ t$$
$${Y}_{hi}^{P . m i n} \cdot {u}_{hi}^{B} \leq {p}_{hi . t}^{BR} \leq {Y}_{hi}^{P . m ax} \cdot {u}_{hi}^{B} , ∀ ( h , i ) ∈ B , ∀ t$$
$${Y}_{hi}^{Q . m i n} \cdot {u}_{ij}^{B} \leq {q}_{hi . t}^{BR} \leq {Y}_{hi}^{Q . m ax} \cdot {u}_{ij}^{B} , ∀ ( h , i ) ∈ B , ∀ t$$
where N is the set of nodes; B is the set of lines;
$${p}_{hi . t}^{B R} and {p}_{ij . t}^{B R}$$
respectively indicate active powers flowing through the line (h,i) and the line (i,j) at time step t;
$${q}_{hi . t}^{B R} and {q}_{ij . t}^{B R}$$
respectively indicate reactive power flowing through the line (h,i) and the line (i,j) at time step t;
$${P}_{i . t}^{G}$$
indicates the active power output of the gas turbine connected at node i at the time step t;
$${Q}_{i . t}^{G}$$
indicates a reactive power output of the gas turbine connected at node i at time step t; P_{i.t} indicates the active power restoration amount of the load at node i at time step t; Q_{i.t} indicates the reactive power restoration amount of the load at node i at time step t;
$${u}_{h i}^{B}$$
is used to characterize whether the line (h,i) is in the fault state,
$${u}_{h i}^{B} = 0$$
indicates the line is in the fault state, otherwise
$${u}_{h i}^{B} = 1 ; {u}_{i j}^{B}$$
is used to characterize whether the line (i,j) is in the fault state; if the line (i,j) is in the fault state,
$${u}_{i j}^{B} = 0$$
indicates the line is in the fault state, otherwise
$${u}_{i j}^{B} = 1 ; {Y}_{h i}^{P . m i n}$$
indicates the minimum active power allowable through line (h,i);
$${Y}_{h i}^{P . m ax}$$
indicates the maximum active power allowable through line (h,i);
$${Y}_{h i}^{Q . m i n}$$
indicates the minimum reactive power allowable through line (h,i);
$${Y}_{h i}^{Q . m ax}$$
indicates the maximum reactive power allowable through line (h,i).

8. The method for according to claim 2, wherein determining the following variables based on the target data and subject to the overall constraint, with an objective of maximizing the weighted load restoration during the fault duration: the travel trajectory of refueling vehicles and their fuel delivery amount at each gas turbine node, the output power of each gas turbine, and the load restoration amount of each load node, comprises:
obtaining, subject to the overall constraints and with the power restoration objective of maximizing the weighted load restoration during the fault duration, the travel trajectory of refueling vehicles and their fuel delivery amount at each gas turbine node, the output power of each gas turbine, and the load restoration amount of each load node through mathematical planning by a mathematical planner.

9. The method according to claim 8, wherein the mathematical planner is one of an integer planner, a liner planner or a mixed integer linear planner.

10. The method according to claim 1, wherein controlling the operating status of load nodes and the output power of gas turbines, and the fuel delivery by refueling vehicles to each gas turbine node based on the travel trajectory of refueling vehicles, the fuel delivery amount of the refueling vehicle at each gas turbine node, the output power of each gas turbine and the load restoration amount of each load node, comprises:
generating the refueling vehicle scheduling control instruction, the gas turbine scheduling instruction, and the load node scheduling instruction according to the travel trajectory of the refueling vehicle on the roads in the disaster-affected area, the fuel delivery of the refueling vehicle at each gas turbine node, the output power of each gas turbine and the load restoration amount of each load node, wherein the refueling vehicle scheduling control instruction comprises the driving route, the departure time, the fuel delivery amount, and the stop node of the refueling vehicle;
controlling the output power of gas turbines according to the gas turbine scheduling instruction;
controlling the operating status and load restoration amount of the load node according to the load node scheduling instruction; and
controlling the refueling vehicle to deliver fuel to each gas turbine node according to the refueling vehicle scheduling control instruction.

11. The method according to claim 10, wherein the refueling vehicle scheduling control instruction comprises time series data of each refueling vehicle, and the time series data comprises an expected travel path, an expected position and expected remaining fuel amount of the refueling vehicle at each time node.

12. A system for post-disaster power restoration system in a power grid, comprising a microgrid controller, a refueling vehicle and gas turbines, wherein the microgrid controller, the refueling vehicle and the gas turbines are all equipped with communication modules;
the microgrid controller is configured to generate a control instruction for the refueling vehicle by means of the method according to claim 1 after acquiring target data of a disaster-affected area;
the microgrid controller is configured to send the control instruction to the refueling vehicle;
the refueling vehicle, after receiving the control instruction, is configured to select the gas turbine according to the control instruction and drives to the gas turbine to deliver fuel to the gas turbine.

13. The system according to claim 12, wherein one or more refueling vehicles are prepared in the disaster-affected area, the microgrid controller acquires states of the refueling vehicles in the disaster-affected area in real time by means of the communication modules, and the state of the refueling vehicle comprises the travel path, the position and the remaining fuel amount of the refueling vehicles.

14. The system according to claim 12, further comprising load node devices, wherein the microgrid controller is also configured to generate load node scheduling instructions and gas turbine scheduling instructions by means of the method according to claim 1 after acquiring the target data of the disaster-affected area, send the load node scheduling instructions to the load node devices and the gas turbine scheduling instructions to the gas turbines; and
the load node scheduling instruction is used for controlling the operating status of load nodes, and the gas turbine dispatching instruction is used for controlling the output power of gas turbines.

15. A computer-readable storage medium, storing a computer program, wherein the computer program, when executed by a processor, implements the method according to claim 1.
